(19) United States
(12) Patent Application Publication
(10) Pub. No.: US 2014/0278984 A1
(43) Pub. Date: Sep. 18, 2014

(54) Dynamic Pricing in Online Content

(71) Applicant: MICROSOFT CORPORATION, Redmond, WA (US)

(72) Inventors: Weiguo Liu, Dublin, CA (US); Ye Chen, Sunnyvale, CA (US)

(73) Assignee: Microsoft Corporation, Redmond, WA (US)

(21) Appl. No.: 13/841,624

(22) Filed: Mar. 15, 2013

(51) Int. Cl. G06Q 30/02

(52) U.S. Cl. CPC G06Q 30/0276
USPC 705/14.54; 705/14.72; 705/14.68; 705/14.66

(57) ABSTRACT

Systems and methods for presenting dynamic offers to a computer user are presented. In one embodiment, in response to a request for content, one or more items in the content are identified. For each of the items, a determination is made as to whether to offer a dynamic offer for the item is made. For those items where it is determined to make a dynamic offer, the dynamic offer is incorporated into the content. The content is then presented to the computer user. Alternative, a component on the user computer identifies one or more items in content to be displayed to the computer user. The user computer then obtains dynamic offers corresponding to at least some of the identified items and incorporates the dynamic offers into the displayed content.

### BACKGROUND

More and more people are purchasing items over the Internet. Indeed, recent studies have suggested that nearly 90% of all consumers have purchased something online and each year a greater percentage of all purchases are made online. Correspondingly, there are many retail-related web sites to which a computer user can navigate in order to conduct a purchase transaction.

Dynamic pricing is often used by businesses to entice people into impulse purchases, i.e., the purchase of an item based on an immediate urge or impulse. A typical dynamic pricing scenario might occur within a retail store where a public announcement to the customers indicates that, for a limited period of time, a certain product will be offered at a greatly reduced price.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a computer-implemented method for presenting dynamic offers to a computer user is presented. One or more items are identified within a page of content that is to be displayed (or is already displayed) to a computer user. A dynamic determination is made to make a dynamic offer to the computer user for one of the identified items. The page of content is updated to include a presentation of the dynamic offer for the one item and the updated content is provided to the computer user for display.

According to further aspects of the disclosed subject matter, a computer-implemented dynamic offer system for responding to a content request is presented. The dynamic offer system includes a processor and a memory, as well as additional executable components which, together, cause the system to respond to a content request from a computer user. The additional components include an item identification component and a dynamic offer component. The item identification component is configured to identify a set of items in content requested by the computer user. The dynamic offer component dynamically determines whether to provide a dynamic offer and, if so, associates a dynamic offer with at least one item of the identified items in the requested content.

According to still further aspects of the disclosed subject matter, a computer system for displaying content to a computer user is presented. The computer system includes a processor and a memory, as well as additional executable components which, together, cause the computer system to display content to a computer user, where the content includes one or more dynamic offers for items in the content. The additional components include a dynamic offer request component, a content update component, and a content presentation module. The dynamic offer request component is configured to dynamically obtain at least one dynamic offer from a dynamic offer system for an item in the content to be displayed to the computer user. The content update component is configured to update the content with the at least one dynamic offer such that the dynamic offer is presented to the computer user in conjunction with the presentation of the updated content. The content presentation module is configured to present the updated content to the computer user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter, particularly in regard to providing dynamic offers to a computer user;

FIGS. 2A and 2B are block diagrams illustrating exemplary interactions between a user computer and one or more external systems in obtaining and presenting dynamic offers to a computer user;

FIGS. 3A-3E are pictorial diagrams illustrating exemplary presentations of dynamic offers in conjunction with displayed content;

FIG. 4 is a flow diagram illustrating an exemplary routine for obtaining content for presentation to the computer user, wherein the content includes at least one item associated with a dynamic offer;

FIG. 5 is a flow diagram illustrating an exemplary routine, as implemented by a suitably configured component executing on a user computer, for incorporating one or more dynamic offers in the page of content;

FIG. 6 another flow diagram

FIG. 6 is a flow diagram illustrating an exemplary routine for responding to a request for dynamic offers for a set of items;

FIG. 7 is a block diagram illustrating an exemplary network site 700 configured to respond to a request with content that includes one or more dynamic offers; and

FIG. 8 a block diagram an exemplary user computer 800 for display content, including dynamic offers, to a computer user.

### DETAILED DESCRIPTION

For purposed of clarity, the use of the term “exemplary” in this document should be interpreted as serving as an illustration or example of something, and it should not be interpreted as an ideal and/or a leading illustration of that thing. Additionally, the term “item,” in conjunction with a dynamic offer, should be viewed as being a product or service that is available for sale, access, rent or lease. While, for convenience in writing, the term “sell” will most often be used with regard to a dynamic offer for an item, the disclosed subject matter should be viewed as covering sales, rent, lease, or granted access of the item.

The term “dynamic offer” refers to an offer to sell a corresponding item. A dynamic offer is “dynamic” in that a determination to make the dynamic offer to a computer user is made just prior to making the dynamic offer available to the computer user. For example, as a computer user navigates a browser to a network site (i.e., directs the browser to display content from the network site), a determination is dynamically made as to whether or not to make a dynamic offer to the computer user regarding an item in the content at the network site. As will be described in more detail below, even if a determination is made to make a dynamic offer regarding the item to the computer user, the dynamic offer may or may not be displayed with the content depending on whether or not the dynamic offer is dependent on the occurrence of a triggering event before the dynamic offer is presented (displayed) to the computer user. Furthermore, because dynamic offers are based on “at-the-moment” determinations, a dynamic offer for an item that is made to a computer user as the computer user navigates to a specific network site a first time might not be made to the computer user as the computer user navigates to the same network site a subsequent time. A dynamic offer is temporal, meaning that the offer is valid for a limited period of time. The period of time that a dynamic offer is valid may be a fixed period of time or corresponds to the occurrence of a terminating event, such as the computer user navigating away from the network site that includes the item for which the dynamic offer is made. A dynamic offer has a corresponding discount or offer price that is typically, but not necessarily, less than a common price for the item. As suggested above, the purpose of making a dynamic offer to a computer user is to encourage the computer user to make a prompt purchase.

Turning to FIG. 1, FIG. 1 is a block diagram illustrating an exemplary networked environment 100 suitable for implementing aspects of the disclosed subject matter, particularly in regard to providing dynamic offers to computer users. The exemplary networked environment 100 includes one or more user computers, such as user computers 102-106, connected to a network 108, such as the Internet, a wide area network or WAN, and the like. Also connected to the network 108 are various networked sites 110-116. User computers include, by way of illustration and not limitation: desktop computers (such as user computer 104); laptop computers (such as user computer 102); tablet computers (not shown); mobile devices (such as mobile device 106); game consoles (not shown); personal digital assistants (not shown); and the like. A computer user, such as computer user 101, may navigate to these and other networked sites (not shown) to view content hosted on the sites. By way of example and not limitation, the networked sites include a search engine 110, vendor sites 112 and 116, and news site 114.

As will be readily appreciated, the search engine 110 is configured to provide search results (i.e., content) in response to search queries received from one or more persons/computer users, such as computer user 101 by way of user computer 102 over the network 108. In particular, in response to receiving a search query from a computer user, the search engine 110 identifies search results related and/or relevant to the received search query and generates one or more search results pages that include the identified search results as well as additional content. It should be appreciated that search results may include and/or correspond to items for sale or lease. Hence, dynamic offers may be made for an item among the search results. Additional information in the search results pages may also be the subject of dynamic offers. Advertisements included in the search results pages typically correspond to items for sale or lease and dynamic offers may be made in regard to one or more advertisements in addition to items among the search results.

Vendor sites, such as vendor sites 112 and 116, offer items (e.g., products and services) for sale and/or lease. The items available at these vendor sites may be exclusive to the host of the vendor site (i.e., items of the vendor's own line of products), items from other vendors, and/or a combination of the host site's products as well as products of other vendors. In navigating the content of a vendor site, one or more dynamic offers may be made to the computer user in conjunction with corresponding items in the various pages of content.

It should be appreciated that web content sites, such as news site 114, host or reference news content, such as articles, editorials, commentary, and the like generally referred to as articles. As the computer user navigates to view the various articles of a content site, the page of content in which an article is presented will typically include one or more advertisements. Of course, these advertisements correspond to various items and services for sale or lease. Moreover, one or more dynamic offers may be made to the computer user for these various items.

Though FIG. 1 illustrates various network sites 110-116 within the exemplary networked environment 100, the exemplary networked environment is illustrative and should not be viewed as limited upon the disclosed subject matter. Indeed, there may be any number of network sites (as well as user computers) connected to the network 108 providing a variety of content that may include items. Moreover, as a computer user navigates (via a user computer) to these various sites, dynamic offers may be made in association with one or more items in a displayed page of content.

To better understand the process of making a dynamic offer to a computer user, reference is now made to FIGS. 2A and 2B. Turning first to FIG. 2A, this figure illustrates an exemplary interaction 200 between a user computer 102 and an external network site, dynamic offer system 202, in obtaining and presenting one or more dynamic offers to the computer user 101. As indicated by block 204, the computer user 101 navigates to a page of content on the network 108. It should be appreciated that the requested content may correspond to an existing page of content either at the dynamic offer system 202 or elsewhere on the network 108, or to dynamically generated content that is generated in response to the request. By way of illustration and not limitation, a news article on a news site, such as news site 114, is an example of an existing page of content. In contrast, a search results page generated by a search engine, such as search engine 110, in response to a search query is an example of dynamically generated content.

As indicated by block 206, in addition to accessing or generating the requested page of content, the dynamic offer system 202 identifies one or more items among the requested content for which a dynamic offer might be made. At block 208, the dynamic offer system 202 determines for which items a corresponding dynamic offer should be made. The determinations are typically, but not exclusively, made on a per item and/or a per-request basis. Determining whether to make a dynamic offer for an item may be made according to (by way of illustration and not limitation) one or more of: predetermined advertising plans; internal sales and/or fulfillment goals; random selection; consultation with one or more vendors offering the particular items; events such as the Super Bowl™ or World Series™; festivals and holiday seasons/events; and the like. These determinations may be made based on user information corresponding to the requesting computer user include. This user information may include, by way of illustration and not limitation: geographic location, preferences and/or interests (both implicitly and explicitly identified), browsing history, purchase history, search query history, demographics, social networking information (as approved and knowingly shared by the computer user); and the like.

At block 210, for those dynamic offers to be made to the computer user, dynamic offer details are obtained. These details include, by way of illustration and not limitation, an offer price or offer discount of a common price associated with the item, a duration identifying the length of time that the dynamic offer is valid, presentation information identifying the manner in which the dynamic offer is to be presented to the computer user, triggering events that trigger the dynamic offer to be presented to the computer user, offer acceptance data identifying the process for accepting the dynamic offer, and the like. At block 212 the dynamic offers are incorporated into the requested content. At block 214 the requested content is provided to the computer user 101. At block 216, on the user computer 102 the requested content, which includes dynamic offers, is displayed to the computer user 101.

While FIG. 2A illustrates an exemplary interaction 200 between the computer user 101 on a user computer 102 and an external network site, dynamic offer system 202, in obtaining content that includes one or more dynamic offers for the computer user, it is an example of one form of interaction. FIG. 2B illustrates an alternative interaction 225 between the computer user 101 (via user computer 102) and network systems (such as networked sites 222 and 224) in obtaining content that includes one or more dynamic offers for the computer user. As shown in FIG. 2B, at block 226, the computer user 101 navigates to or requests (by way of user computer 102) content available from an external network site, network site 222, over the network 108. At block 228, network site 222 identifies the requested content and, at block 230, the network site 222 returns the requested content to the user computer 102.

At block 232, a dynamic offer component operating on the user computer 102 identifies items in the obtained content for which dynamic offers might be made. At block 234 the component requests dynamic offer details for the identified items. According to various embodiments, identification of items in the content may be made prior to the display of the content to the computer user 101 on the user computer 102 or, alternatively, after the obtained content is displayed to the computer user. Except for the display step of 244, the process 225 is largely the same as that described in process 200. In one embodiment (as shown in FIG. 2B), dynamic offers are obtained from one or more external network sites, such as dynamic offer system 224. However, in an alternative embodiment (not shown), one or more dynamic offers may be locally cached on the user computer 102 such that there is no need to obtain dynamic offer details from external sites, such as dynamic offer system 224. Also, it should be appreciated that network sites 222 and 224 may correspond to the same network site such that a computer user must first obtain content from the site and then obtain dynamic offers from that site corresponding to items in the obtained content. In yet another embodiment, dynamic offers may be obtained from a local cache as well as from external network sites.

At block 236, in response to the request for dynamic offers, dynamic offer system 224 determines for which of the identified items a corresponding dynamic offer will be made to the computer user 101. As discussed above in regard to FIG. 2A, the determinations are typically made on a per-item and/or per-request basis and made according to (by way of illustration and not limitation) one or more of: predetermined advertising plans; internal sales and/or fulfillment goals; random selection; consultation with one or more vendors offering the particular items; or the like. Further, the determinations may be made based on user information corresponding to the requesting computer user include. This user information may include, by way of illustration and not limitation: geographic location, preferences and/or interests (both implicitly and explicitly identified), browsing history, purchase history, search query history, demographics, and the like.

At block 238, dynamic offer details for those dynamic offers to be made to the computer user 101 are obtained. At block 240, the dynamic offers to be made to the computer user 101, including the dynamic offer details, are returned to the user computer 102. At block 242, the presentations of the dynamic offers are included in the obtained content and, at block 244, the content with the dynamic offers is displayed to the computer user 101.

While not shown, in various embodiments a combination of the two exemplary interactions may also be implemented. In particular, in addition to obtaining a page of content from an external network site, where the obtained page of content already includes one or more dynamic offers, the component on the user computer 102 (discussed above in regard to FIG. 2B) may also obtain additional dynamic offers from other network sites or its own cache of dynamic offers.

To illustrate the visual presentation of dynamic offers, reference is now made to FIGS. 3A-3E. FIGS. 3A-3E are pictorial diagrams for illustrating exemplary presentations of dynamic offers in the context of an obtained page of content. With regard to FIGS. 3A-3C, the obtained page of content is a response to a product listing request for “tablet computers.” Turning first to FIG. 3A, this figure illustrates an exemplary browser view 300 showing content 302 including various products (e.g., product listings 306-312) that have been identified as satisfying the product listing request 304 “tablet computers.” In this exemplary browser view 300, a dynamic offer is being made in regard to the item of product listing 308, as indicated by dynamic offer presentation 314.

According to various embodiments, a computer user accepts a dynamic offer, such as the dynamic offer represented by dynamic offer presentation 314, by interacting with the dynamic offer presentation. The specific manner in which a computer user interacts with a dynamic offer presentation, such as dynamic offer presentation 314, depends on the user interface paradigm of the user computer and the particular manner in which the vendor offering the dynamic offer has specified (through the dynamic offer details discussed above.) Interaction may comprise, by way of illustration and not limitation, clicking on the dynamic offer presentation (as is known in the art), making a specific key-press identify by the dynamic offer presentation, touching the dynamic offer presentation on the display device of the user computer, speaking a command, making a gesture that is detectable by the user computer (e.g., detectable by camera, triangulation, accelerometers, etc.), and the like. As indicated above, if the computer user does not to accept (and, therefore does not interact with) the dynamic offer within the predetermined amount of time associated with the dynamic offer, the dynamic offer becomes invalid. Alternatively, termination events may terminate a dynamic offer, such as navigating away from the content 302 in which the dynamic offer is presented. In various embodiments, when the dynamic offer is no longer valid, the corresponding offer presentation, such as offer presentation 314, is no longer displayed with the content 302. The content 302 may further be included in sponsored search results of a search results page.

While not shown, dynamic offer presentations, such as offer presentation 314, are not necessarily static presentations. Dynamic offer presentations may be configured to be displayed in any number of manners. Dynamic offer presentations may include color, color changes, animation, and the like. The level of discount associated with a dynamic offer may be reflected in the particular presentation of the dynamic offer. For example, the amount of discount associated with the dynamic offer may be reflected in the color of the dynamic offer presentation, where greater discounts are displayed in a more intense color than those dynamic offers with lesser discounts. Hence, turning to FIG. 3B, the illustrative browser view 300 includes two dynamic offers as illustrated by dynamic offer presentations 316 and 318. Assuming that those dynamic offers having a greater discount are presented in darker hues/colors than those dynamic offers having lesser discounts, a computer user can readily see that the dynamic offer for product listing 308 (as indicated by dynamic offer presentation 318) is greater than the dynamic offer for product listing 310 (as indicated by dynamic offer presentation 316 displayed in a lighter shade of grey.) According to various embodiments, different colors and/or hues may be associated with corresponding ranges of discounts. For, in an exemplary embodiment, the color red used in a dynamic offer presentation may correspond to a discount of at least 50%, whereas the color yellow used in a dynamic offer presentation may correspond to a discount of at least 25%. Of course, the color or hue can easily be made transparent on a computer screen so that the original price can still be viewed. Indeed, it should be appreciated that while it is advantageous to deliver as much information as possible to the computer user, the amount of space available to present a dynamic offer is often quite limited such that simple indicates without a lot of detail will be used.

According to various embodiments, the amount of discount of a dynamic offer may be a function of the length of time that computer user takes to accept the offer (through interaction with the presentation of the dynamic offer). For example a dynamic offer may begin with a price discount of 50% off of a normal price for an item, and be reduced to a 10% discount just prior to the expiration of the dynamic offer. In another non-exclusive embodiment, a dynamic offer presentation may indicate the amount of time that is remaining for the dynamic offer. For example, FIG. 3C illustrates dynamic offer presentations 320 and 322 corresponding to dynamic offers associated with the items of to product listings 306 and 312. In this example, offer presentations 320-322 act are illustrated as count-down timers showing the time remaining to accept the corresponding dynamic offer before their expiration.

While the offer presentations shown in FIGS. 3A-3C are illustrated as being located above a price for the corresponding item, this is illustrative and not limiting upon the disclosed subject matter. While it may be useful to cover or overlay a “standard” price in order to attract the attention of a computer user as well as indicate a different price, the presentation of a dynamic offer may be placed in any number of locations with regard to an item.

In contrast to the product listings shown in FIGS. 3A-3C, FIG. 3D illustrates a search results page 350 including search results corresponding to the search query 352, “digital cameras.” The search results page includes various search results 360 as well as a product bar 354 that includes various items for sale, including item 356. As can be seen, a dynamic offer is available to the computer user for item 356 as indicated by dynamic offer presentation 358. Further still, FIG. 3E illustrates a news page 370 that includes an advertisement 372 having an associated dynamic offer, as indicated by the dynamic offer presentation 374. It should be appreciated that a dynamic offer, such as the dynamic offer associated with dynamic offer presentation 374, may come from any vendor. For example, while advertisement 372 may have been posted by the producer (Lenovo) of the computer, the dynamic offer associated with dynamic offer presentation 374 may come from a 3^{rd} party vendor.

As suggested above, according to various embodiments of the disclosed subject matter, the presentation of a dynamic offer does not necessarily coincide with the display of a page of content that includes the dynamic offers. Indeed, a dynamic offer may be associated with an item but, according to dynamic offer details, becomes active and is and presented to a computer user based on the occurrence of a triggering event. Triggering events may include, by way of illustration and not limitation, hovering over an item with a pointing device, initial interaction with an item, a time of day, active display of the item for a pre-established amount of time, and the like.

Turning now to FIG. 4, FIG. 4 is a flow diagram illustrating an exemplary routine 400 for obtaining content for presentation to the computer user, wherein the content includes at least one item associated with a dynamic offer. Generally speaking, the routine 400 is implemented by a network site, such as network site 202, which hosts or provides content. Beginning at block 402, a request for content is received from a requesting computer user, such as computer user 101. The request may identify existing content such as request for an existing news article hosted by a news service. Alternatively, the request may be directed to a service for content to be generated. Additionally, as suggested previously, according to aspects of the disclosed subject matter, the request includes or is accompanied with user identification information that can be used to uniquely identify the requesting computer user and obtain corresponding user related information upon which a determination to make a dynamic offer may be based.

After identifying (or generating) the requested content, at block 404, a set of items within the page of content is identified. These identified items are potential candidates for which corresponding dynamic offers may be made. At block 406, an iteration loop is begun to iterate through the set of identified items in the requested content. As those skilled in the art will appreciate, in iterating through the identified items, each item in turn is selected as a current item and processed. Iteration continues until all items have been processed. Hence, for each identified item, at decision block 408 a determination is made as to whether to make a dynamic offer to the computer user 101 for the currently iterated item. If it is determined to not make a dynamic offer for the currently iterated item, the routine 400 returns to block 406 where the next identified item is selected for processing. Alternatively, if a dynamic offer is to be made in association with the currently iterated item, the routine 400 proceeds to block 410.

In regard to the determination made in decision block 408 regarding whether to make a dynamic offer for the currently selected item to the computer user 101, typically, but not exclusively, these determinations are made on a per item basis. Determining whether to make a dynamic offer for the currently selected item may be made according to (by way of illustration and not limitation) one or more of: predetermined advertising plans; internal sales and/or fulfillment goals and metrics regarding the advertisement or sale of an item; random selection; consultation with one or more vendors offering the particular items; and the like. These determinations may be made based on user information corresponding to the requesting computer user include. The user information is typically, but not exclusively, obtained according to the user identification information that is included in (or accompanies) the content request from the computer user. This user information may include, by way of illustration and not limitation: geographic location, preferences and/or interests (both implicitly and explicitly identified), browsing history, purchase history, search query history, demographics, and the like.

At block 410, details regarding the dynamic offer for the currently selected item to be made to the computer user are obtained. These dynamic offer details may include, without limitation: the price or discount associated with the dynamic offer; the length of time that the dynamic offer remains valid; triggering events to occur before the offer becomes valid (and presented); terminating events that terminate dynamic offer (other than expiration of time); the type of dynamic offer presentation; the mode of accepting the dynamic offer; and the like. These dynamic details may be included with a corresponding pre-established plan or may be obtained from the vendor/producer/promoter of the item. After obtaining the dynamic offer details for the dynamic offer for the current selected item, the routine 400 returns to block 406 where the iteration to the next identified item continues.

After iterating through all of the identified items, at block 412, the dynamic offers (those that are to be made to the computer user) are incorporated into the requested content to be returned to the computer user 101. As a result, the requested content includes information and/or code for presenting the dynamic offer to the computer user for each of the identified products having a corresponding dynamic offer. At block 414, the requested content is returned to the computer user 101 in response to the computer user's request. Thereafter, the routine 400 terminates.

Regarding the requested content discussed above in regard to routine 400, as mentioned above while a requested page of content may correspond to a predetermined, static or mostly static page of content, the disclosed subject matter is not so limited. Indeed, the request page of content may be generated in response to the request. For example, the browser view 300 shown in FIGS. 3A-3C would typically be generated in request to a product listing request from an online shopping service. Similarly, the search results page 350 was generated in response to a search engine receiving the search query 352 “digital cameras.” In contrast, news page 370 of FIG. 3E is an example of a static (or mostly static) page of content. Those pages of content that are mostly static have content that remains the same but elements of the content (such as advertisements) are dynamically determined.

Regarding routine 400, as well as the other routines described below, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 400 (as well as 500 and 600 discussed below) may be carried out in parallel or in series. Often, but not exclusively, the functionality of the various routines is embodied in software (e.g., applications, system services, libraries, and the like) that is executed on computer hardware and/or systems as described below in regard to FIGS. 7 and 8. In various embodiments, all or some of the various routines may also be embodied in hardware modules, including system on chips, on a computer system.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions store stored on the computer-readable storage devices are executed, they carry out various steps, methods and/or functionality, including those steps, methods, and routines described above in regard to routines 400, 500 and 600. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

FIG. 4 presents routine 400 for processing a request for content from a computer user and would be typically implemented by a network site and/or service, such as network site 202. In the context of routine 400, it is the network site that processes the computer user's request, identifies (or generates) the requested content, identifies the items in the requested content, and determines for which items a dynamic offer is to be made to the computer user 101. However, in an alternative embodiment, a component executing on a user computer, such as user computer 102, may be used to identify items on a page of content to be displayed to the computer user, consistent with the process described in regard to FIG. 2B. To that end, FIG. 5 is a flow diagram illustrating an exemplary routine 500, as implemented by a suitably configured component executing on a user computer, for incorporating one or more dynamic offers in the page of content.

Beginning at block 502, the user computer obtains a page of content for display to the computer user 101. At block 504, an item identification component identifies one or more items in the page of content for which a dynamic offer may be made. At block 506, for efficiency purposes, the item identification component optionally identifies dynamic offers for corresponding identified from a local cache on the user computer. As will be readily appreciated, the identification of dynamic offers from a local cache may include determining whether to make a dynamic offer to the computer user 101 for a particular item based on various criteria, as previously discussed.

At block 506, a request is made of an external network site, such as dynamic offer system 224, to obtain dynamic offers for the identified items (or for those identified items for which there is not already a corresponding dynamic offer). After obtaining the dynamic offers in response to the request, at block 510 the dynamic offers (those obtained from local cache—if any—as well as those obtained from an external network site such as dynamic offer system 224) are incorporated into the page of content such that they may be displayed with the content to the computer user 101. At block 512, the page of content is displayed to the computer user and includes dynamic offers for corresponding items in the page. Thereafter, routine 500 terminates.

Of course, it should be appreciated that, according to various aspects of the disclosed subject matter, even at the beginning of routine 500 the page of content may include dynamic offers. This may arise when a page of content is obtained from a network site that included one or more dynamic offers in the page of requested content

FIG. 6 is a flow diagram illustrating an exemplary routine 600 for responding to a request for dynamic offers for a set of items (such as suggested in block 508 of FIG. 5.) Beginning at block 602, a list of items is received from a computer user. As an alternative to receiving a list of items (not shown), the content that includes the items may be obtained and the items identified from the content. In any event, with the identified items, at block 604 an iteration loop is begun to iterate through the identified items. Hence, at decision block 606, a determination is made as to whether to make a dynamic offer for the currently iterated/selected item. If not, the routine 600 returns to block 604 and the process repeats until there are not more items to select. However, if the determination is made to make a dynamic offer for the currently selected item, at block 608 the details regarding the dynamic offer are obtained. Thereafter, the routine 600 returns to block 604 and continues until the process has iterated through each of the identified items.

At block 610, the dynamic offer details (for those dynamic offers to be made to the computer user) are returned to the requesting computer user and the routine 600 terminates. Of course, if (as suggested above) the computer user submits the content rather than a list of items, the routine 600 would incorporate the dynamic offers into the content before returning the content to the computer user.

Turning now to FIG. 7, FIG. 7 is a block diagram illustrating an exemplary network site 700 configured to respond to a request with content that includes one or more dynamic offers. As shown in FIG. 7, the network site 700 includes a processor 702 (or processing unit) and a memory 704 interconnected by way of a system bus 710. As those skilled in the art will appreciated, memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. Generally speaking, RAM and CPU cache memory are examples of volatile memory whereas ROM and memory cards are examples of non-volatile memory.

The processor 702 executes instructions retrieved from the memory 704 in carrying out various functions, particularly in responding to product listing requests with product listing pages that may include dynamic offers. The processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 710 provides an interface for the various components to inter-communicate. The system bus 710 can be of any of several types of bus structures that can interconnect the various components (including both internal and external components). The network site 700 further includes a network communication component 712 for interconnecting the network site with other computers (including, but not limited to, user computers such as user computers 102-106, other network sites including network sites 112-116, and a search engine 110) as well as other devices on a computer network 108. The network communication component 712 may be configured to communicate with an external network, such as network 108, via a wired connection, a wireless connection, or both.

The network site 700 also includes an item identification component 716. The item identification component 716 scans content (or pages of content) and identifies items within content that are candidates for making a dynamic offer. In short, the item identification component 716 identifies the items in the content for which a dynamic offer may be made.

Also included in the network site 700 is a dynamic offer component 720. The dynamic offer component 720 is used to determine whether to offer a dynamic offer to the computer user for a specific item. Typically, the dynamic offer component 720 operates in conjunction with the item identification component 716, making determinations as to whether to offer a dynamic offer to the computer user in conjunction with an item identified by the item identification component. The content update component 718 incorporates the dynamic offers (as determined by the dynamic offer component 720) into the content which is then returned to the computer user.

Also included in the network site 700 is a content store 726 that stores content that may be requested by the computer user. A dynamic offer store 722 includes information regarding one or more dynamic offers that may be made to computer users in conjunction with one or more items. Also, a user profile store 724 includes user information corresponding to a plurality of users. Typically, but not exclusively, the user information is obtained according to the user identification information that accompanies a content request.

It should be appreciated that the network site 700 may be configured to respond to computer user requests for content which may include one or more dynamic offers. Alternatively or in addition to being configured to respond to content requests, the network site may also respond to requests for dynamic offers from a computer user, such as described in regard to routine 600 of FIG. 6.

FIG. 8 is a block diagram illustrating a user computer 800 configured to display content including dynamic offers to a computer user. Generally speaking, a user computer, such as user computer 800, is a computer that is accessible to and/or used by a computer user. Similar to the network site 700 of FIG. 7, the user computer 800 includes a processor 802 (or processing unit) and a memory 804 interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory whereas ROM and memory cards are examples of non-volatile memory.

The processor 802 executes instructions retrieved from the memory 804 in carrying out various functions, particularly in identifying items for which a dynamic offer may be made as well as displaying content that includes dynamic offers. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 810 provides an interface for the various components to inter-communicate. The system bus 810 can be of any of several types of bus structures that can interconnect the various components (including both internal and external components). The search engine 110 also includes a network communication component 812 for interconnecting the vendor site with other computers (including, but not limited to, user computers including user computers 102-106, and network sites including network sites 110-116) as well as other devices on a computer network 108. The network communication component 812 may be configured to communicate with an external network, such as network 108, via a wired connection, a wireless connection, or both.

The user computer 800 also includes an item identification component 816. The item identification component 816 scans content (or pages of content) to be displayed on the user computer by way of a content presentation module 814 and identifies items within content that are candidates for making a dynamic offer.

Also included in the user computer 800 is a dynamic offer request component 820. The dynamic offer request component 820 is used to request/obtain one or more dynamic offers corresponding to items in content from a network site, such as network site 700. Typically, the dynamic offer request component 820 operates in conjunction with the item identification component 816, in requesting dynamic offers from items identified by the item identification component. The content update component 818 incorporates the dynamic offers obtained by the dynamic offer request component 820 into the content which is then displayed to the computer user. As indicated above, a local cache 822 may include one or more dynamic offers for purposes of efficiency.

Those skilled in the art will appreciate that the various components of FIGS. 7 and 8 described above may be implemented as executable software modules within the computer systems, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the network site 700 and the user computer 800 should be viewed as logical components for carrying out the various described functions. As those skilled in the art appreciate, logical components (or subsystems) may or may not correspond directly, in a one-to-one manner, to actual, discrete components. In an actual embodiment, the various components of each computer system may be combined together or broke up across multiple actual components and/or implemented as cooperative processes on a computer network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for presenting dynamic offers to a computer user, the method comprising:
identifying an item in content for display to the computer user on a user computer;
dynamically determining to make a dynamic offer to the computer user for the identified item;
updating the content to include a presentation of the dynamic offer for the item; and
providing the updated content to the computer user for display to the computer user.

2. The computer-implemented method of claim 1, wherein dynamically determining to make a dynamic offer to the computer user for the identified item comprises identifying a vendor that is willing to make a dynamic offer for the identified item to the computer user.

3. The computer-implemented method of claim 2, wherein dynamically determining to make a dynamic offer to the computer user for the identified item further comprises identifying a vendor that is willing to make a dynamic offer for the identified item to the computer user based on demographics of the computer user.

4. The computer-implemented method of claim 2 further comprising dynamically obtaining a discount amount of the dynamic offer from the vendor for the identified item.

5. The computer-implemented method of claim 2 further comprising dynamically obtaining an offer period of the dynamic offer, the offer period identifying the amount of time between presentation of the dynamic offer to the computer user and expiration of the dynamic offer.

6. The computer-implemented method of claim 1, wherein updating the content to include a presentation of the dynamic offer for the item comprises updating the content with a dynamic offer such that the dynamic offer is presented to the computer user after triggering event has occurred.

7. The computer-implemented method of claim 6, wherein the triggering event comprises any one of hovering over the identified item, selecting the identified item, and reviewing additional detail of the identified item.

8. The computer-implemented method of claim 1, wherein dynamically determining to make a dynamic offer to the computer user for the identified item comprises determining to make a dynamic offer to the computer user for the identified item according to a pre-established plan.

9. The computer-implemented method of claim 8, wherein determining to make a dynamic offer to the computer user for the identified item comprises determining to make a dynamic offer to the computer user for the identified item according to a pre-established plan based on demographics of the computer user.

10. A computer-implemented dynamic offer system for responding to a content request, the system comprising a processor and a memory, wherein the processor executes instructions stored in the memory as part of or in conjunction with additional components to respond to a content request from a computer user, the additional components comprising:
an item identification component configured to identify a set of items in content requested by the computer user; and
a dynamic offer component configured to dynamically associate a dynamic offer with at least one item of the identified items in the requested content.

11. The computer-implemented dynamic offer system of claim 10 further comprising a content update component configured to include a presentation of the dynamic offer associated with the at least one item in the requested content.

12. The computer-implemented dynamic offer system of claim 10, wherein the dynamic offer component is further configured to dynamically determine whether to make a dynamic offer to the computer user for each of the identified items in the set of identified items.

13. The computer-implemented dynamic offer system of claim 12, wherein the dynamic offer component dynamically determines whether to make a dynamic offer to the computer user for a first item of the set of identified items by identifying a vendor willing to make a dynamic offer to the computer user for the first item.

14. The computer-implemented dynamic offer system of claim 12, wherein the dynamic offer component dynamically determines whether to make a dynamic offer to the computer user for a first item of the set of identified items by identifying a vendor willing to make a dynamic offer to the computer user for the first item based on demographics of the computer user.

15. A computer system for displaying content to a computer user, the system comprising a processor and a memory, wherein the processor executes instructions stored in the memory as part of or in conjunction with additional components to display content to the computer user, the additional components comprising:
a dynamic offer request component configured to dynamically obtain at least one dynamic offer from a dynamic offer system for an item in the content for display to the computer user;
a content update component configured to update the content with the at least one dynamic offer such that the dynamic offer is presented to the computer user in conjunction with the presentation of the updated content; and
a content presentation module configured to provide the updated content to the computer user.

16. The computer system of claim 15, wherein updating the content with the at least one dynamic offer for an item in the content comprises including data in the content for presenting the at least one dynamic offer such that the at least one dynamic offer fades as a function of the amount of time until the at least one dynamic offer is invalid.

17. The computer system of claim 15, wherein updating the content with the at least one dynamic offer for an item in the content comprises including data in the content for presenting the at least one dynamic offer such that a color of the presentation of the at least one dynamic offer is selected as a function of a discount of the at least one dynamic offer for the item.

18. The computer system of claim 15, wherein updating the content with the at least one dynamic offer for an item in the content comprises including data in the content for presenting a count-down timer indicative of the amount of time until the at least one dynamic offer is invalid

19. The computer system of claim 15, wherein updating the content with the at least one dynamic offer for an item in the content comprises including data in the content for presenting the at least one dynamic offer after an occurrence of a triggering event.

20. The computer system of claim 14, wherein the triggering event comprises any one of hovering over the identified item, interacting with the identified item, and reviewing additional details of the identified item.
